(19) United States
(12) Patent Application Publication
(10) Pub. No.: US 2020/0122403 A1
(43) Pub. Date: Apr. 23, 2020

(54) GENERATING AN OBJECT REPRESENTATION TO BE MANUFACTURED

(71) Applicant: UNIVERSITY OF BATH, Bath (GB)

(72) Inventors: Vimal DHOKIA, Bath (GB); Joseph FLYNN, Bath (GB); Wesley ESSINK, Bath (GB)

(21) Appl. No.: 16/477,869

(22) PCT Filed: Jan. 19, 2018
(86) PCT No.: PCT/GB2018/050047

§ 371 Date: Jul. 12, 2019

(30) Foreign Application Priority Data
Jan. 12, 2017 (GB) 1700545.5
Jan. 20, 2017 (GB) 1701035.6

(51) Int. Cl. B29C 64/393; G06F 30/17; G05B 19/4099; G06F 30/23; G06F 111/18; G06F 111/04; B33Y 50/02; G06F 111/06

(52) U.S. Cl. CPC B29C 64/393; G06F 30/17; G05B 19/4099; G06F 2111/06; G06F 2111/18; G06F 2111/04; B33Y 50/02; G06F 30/23

(57) ABSTRACT

The present application describes techniques for generating a representation of an object to be manufactured. Method are disclosed which involve the simulated manufacture of the object in a design space such as a volume element world. The simulated manufacture may be based on one or more of: a manufacturing protocol, an object design protocol and at least one boundary condition.

The present application describes techniques for representing and/or designing an object. In particular, the present application describes techniques for generating a representation of an object to be manufactured.

Numerous drawing programs are known which aid the creation, modification, analysis or optimisation of object geometries. In particular, the use of computer-aided design (CAD) techniques is well known and may be used to facilitate the design of an object and/or to enable the optimisation of an object's geometry and/or topology. CAD output is often in the form of electronic files for print, machining, or other manufacturing operations. It will be appreciated that CAD is an important industrial art that is used extensively in many applications. Indeed, the need to design, adapt and optimise the geometry and/or topology of a part for a particular use or purpose arises in many applications, including in automotive, shipbuilding and aerospace industries, as well as in industrial and architectural design, the design of prosthetics and many more.

Known drawing techniques and systems, such as CAD, involve supplying an initial representation of an object's geometry for visualisation within a virtual design space often using vector-based graphics to depict the object. Drawing systems are typically utilised in conjunction with one or more other techniques—such as finite element analysis (FEA)—which enable the adaption or optimisation of that geometry and/or the topology of the part.

Thus, according to known techniques for designing or optimising an object, it is necessary to provide an initial representation of the object's geometry as a starting point for subsequent analysis or optimisation. Thus, known drawing systems like CAD require prior, or assumed, knowledge of the object. This limits the possible candidate solutions of the system to a subset of the geometry initially provided and, thus, to the imagination and/or skill of the designer or draughtsman.

This difficulty is compounded by significant advances made in manufacturing industries to include so-called additive manufacturing processes whereby 3D objects are built by adding layer-upon-layer of material (such as 3D printing) and hybrid manufacturing processes which involve additive and subtractive (controlled removal of material) techniques. These processes have unlocked previously unattainable levels of complexity in the geometry of manufactured parts. As such, objects for manufacture can be very difficult to design, evaluate and optimise using traditional drawing systems. Evaluating the manufacturability of an object is an important part of the design-stage of object development. Current techniques for evaluating an object for manufacture by additive or hybrid techniques are often inefficient, requiring numerous iterations of an initial input design to properly evaluate the manufacturability of the object.

There is therefore a need to improve the technologies available for designing objects for manufacture and for designing increasingly complex object geometries. There is a further need to improve the effectiveness and efficiency of techniques available for evaluating objects for manufacture.

Examples described herein relate to methods and tools for generating a representation, such as a visual representation, of an object to be manufactured. In particular, examples described herein seek to improve the effectiveness and efficiency of designing an object to be manufactured and/or of evaluating a representation of an object to be manufactured.

According to an example of an embodiment of a first aspect of the present invention there is provided a method of generating a representation of an object to be manufactured, the method comprising simulating manufacture of the object in a design space based on:

i) a manufacturing protocol which defines one or more manufacturing parameters relating to a manufacturing process for manufacturing the object;
ii) a design protocol which defines one or more design parameters relating to the object to be manufactured; and
iii) at least one boundary condition which defines at least one boundary of a design region within which material forming the object to be manufactured is allowed to exist.

Example embodiments of the first aspect thus generate a representation of an object for manufacture. The representation generated can be considered to be a candidate design of the object. The representation generated may comprise a set of values and/or instructions defining one or more geometric parameters of a candidate design of the object. Thus, the representation may be considered to be a geometrical representation of the object to be manufactured. The representation may comprise a visual representation. The representation may comprise computer-readable description of the geometry of a candidate design to be manufactured.

The representation may correspond to a 2-dimensional visual representation or a 3-dimensional visual representation. The representation may be visualised within a real-world design space, such as on paper. The representation may be depicted e.g. on an electronic display device—within a “virtual” space, which may be considered to be a virtual design space.

A visual virtual design space may comprise an array of volume elements—e.g. voxels—which divide the 3-dimensional virtual space. Each volume element may comprise a regular polyhedron. Preferably, each volume element comprises a cube. All volume element may be the same size. It will be appreciated that the unit size of the volume element at least partly determines the resolution of the geometries of the representation that may be created. Thus, a representation generated according to an example described herein may be considered to comprise a plurality of interconnected volume elements.

The manufacturing protocol defines one or more manufacturing parameters relating to the manufacture of the object. The manufacturing protocol may comprise a definition e.g. a set of instructions and/or values which specify a parameter (e.g. a rule) that arises as a consequence of the manufacturing process. Thus, the manufacturing parameter may arise as a consequence of conditions, requirements, limits or characteristics relating to the intended or proposed manufacture of the object.

Thus, according to example embodiments of the first aspect, the manufacturing protocol may comprise a set of values which define at least one parameter or rule associated with an additive manufacturing technique, such as 3D printing, a subtractive manufacturing technique, such as CNC machining, or a hybrid manufacturing process that comprises both additive and subtractive manufacturing techniques.

The design protocol defines one or more design parameters relating to the object to be manufactured. For example, the design protocol may include a definition of an initial starting geometry of the object to be manufactured and/or a definition of one or more required attributes of the object.

The boundary conditions may define any geometrical limits of a design region of the design space within which the representation of the object to be manufactured may be generated. A design region may be considered to be a point, line, plane or volume in an n-dimensional space that represents a permissible region. Thus, the boundary conditions may define a) one or more regions where material forming the object is required and/or b) one or more regions where material forming the object is forbidden (e.g. a void). It will be appreciated that a boundary condition may arise as a result of constraints associated with an attribute of the object to be manufactured or from constraints associated with the intended manufacturing process of the object. As such, the boundary conditions may be defined separately or as part of the manufacturing protocol or as part of the design protocol.

It is envisaged that the manufacturing and design protocols may be e.g. a list of instructions and/or values. Thus, the manufacturing and design protocols may form a list of computer-readable instructions or values. The manufacturing and design protocols may be derived/specified and input by an end-user of a method according to an example embodiment. Thus, for example, users with different manufacturing capabilities will be able to generate unique design representations having different geometries. Alternatively, or additionally, the manufacturing and design protocols may be stored remotely e.g. on a remote server or on the cloud, and transmitted to a simulation unit operable to perform simulated manufacture of an object.

Methods carried out in accordance with the examples described herein may be performed iteratively in order to generate a series of representations of the object until e.g. a final design of the object for manufacture is reached. According to one or more examples, a first representation obtained after a first iteration of a method according to an example embodiment may be subsequently modified to take into account additional parameters, and/or by changing the scope of the first set of parameters that the initial simulation of manufacture was based on. For example, it is envisaged that a subsequent representation may be generated which takes into account a calculation of e.g. stress and strain, temperature or fluid flow within different regions of the object's geometry allowing the design to be modified accordingly. This may be represented e.g. by means of a “pheromone map” which may be derived by a method of finite element analysis.

A final representation of an object may be subsequently utilised as a design template in a method of manufacture of the part. The design template may be in the form of computer-readable instructions, a 2-D diagrammatic representation (e.g. on an electronic display or on a printed page) or may be in the form of a 3-D representation.

According to one or more example embodiments of the first aspect the method comprises:

generating a design template from the representation.

The design template may comprise a 2D or a 3D model. A 3D model for use as a design template may be fabricated using an additive manufacturing process or a hybrid manufacturing process. For example, a 3D model may be fabricated by a method of 3D printing.

According to one or more example embodiments of the first aspect the method comprises:

manufacturing a 3D object in accordance with the representation and/or in accordance with a design template generated from the representation.

The object may be fabricated using an additive manufacturing process or a hybrid manufacturing process. For example, the object may be fabricated by a method of 3D printing.

It will be appreciated that one or more parameters that are to be used during the simulated manufacture according to example embodiments of the present invention may be characterised by at least two of: the manufacturing protocol, the design protocol or a boundary condition. Thus, there is a potential overlap in the classification of one or more parameters. For example, a physical/geometric constraint of the manufacturing system that arises e.g. as a consequence of the need to provide access for a tool of the manufacturing apparatus, may be classified as a manufacturing parameter, a design parameter or a boundary condition.

Furthermore, it will be appreciated that the necessity for a void defined by the one or more boundary conditions may be prior knowledge e.g. arising from consideration of the functions or external parts and subsystems. Alternatively, a void defined by the design protocol will tend to be a consequence of engineering features that help the object to perform a function—e.g. a hole for a fastening, a planar face on which to mount other parts or known ports for inlet and outlet flow of fluids.

Simulating manufacture of the object may be achieved in a number of ways. For example, manufacture may be simulated within a virtual design space which is divided into a plurality of volume elements. According to one example, one or more “virtual agents” may be provided within the virtual design space for carrying out the simulated manufacture. Each virtual agent is able to travel and perform work within the virtual space.

A virtual agent may follow a random, a weighted-random or predetermined path or trail. A virtual agent may follow movement instructions or rules. A virtual agent may be operable to follow movement instructions in the form of a pheromone map.

A virtual agent may be provided with a designated manufacturing operation that it is operable to perform at each volume element location. For example, a virtual agent known as an “additive agent”, is operable to add material. Conversely, a virtual agent known as a “subtractive agent” is operable to subtract material.

At each volume element location, a virtual agent may be operable to perform a check to see if it is allowed to perform its designated manufacturing operation. This check will preferably take into account the manufacturing and/or design protocols and/or the boundary condition.

According to a second aspect of the present invention there is provided a tool or apparatus for generating a representation of an object to be manufactured, the tool or apparatus comprising:

a simulation unit configured to simulate manufacture of the object in a design space based on:
i) a manufacturing protocol which defines one or more manufacturing parameters relating to a process for manufacturing the object;
ii) a design protocol which defines one or more design parameters relating to the object to be manufactured; and
iii) at least one boundary condition which defines at least one boundary of a design region within which material forming the object to be manufactured is allowed to exist.

The tool may further comprise one or more of:

a manufacturing protocol storage unit configured to store the manufacturing protocol;
a design protocol storage unit configured to store the design protocol; and
a boundary condition storage unit configured to store the at least one boundary condition.

The boundary condition storage unit may be a separate unit to the manufacturing protocol storage unit and the design protocol storage unit, or it may form a part of the manufacturing protocol storage unit or a part of the design protocol storage unit.

The tool may receive one or more of the manufacturing protocol, the design protocol and the boundary condition from a remote source, such as a remote server or the cloud.

The tool may further comprise a representation storage unit configured to store the representation.

The tool may further comprise a display operable to display the simulated manufacture performed by the simulation unit and/or to display the representation.

An assembly according to one aspect may comprise a tool according to an example embodiment which is provided in conjunction with a manufacturing apparatus operable to receive the representation and to manufacture a 3D object according to the representation. For example, the tool may comprise a 3D printing device.

According to an example of an embodiment of a third aspect there is provided a method of generating a representation of an object to be manufactured comprising simulating manufacture of the object in a virtual design space comprising a plurality of volume elements.

According to one example embodiment of the third aspect the method comprises the addition of material to, and/or removal of material from, each volume element based on at least one of:

i) at least one manufacturing rule relating to the manufacture of the object;
ii) at least one design rule relating to the object to be manufactured; and
iii) at least one boundary condition which defines at least one boundary of a design region within which material forming the object to be manufactured is allowed to exist.

According to an example of an embodiment of a fourth aspect there is provided a simulation unit for simulating the manufacture of an object, comprising: a virtual design space comprising a plurality of volume elements; and at least one virtual agent operable to move between volume elements within the virtual design space and to perform a simulated manufacturing operation at a given volume element.

The manufacturing operation performed by the at least one virtual agent may comprise adding material to a given volume element and/or subtracting material from a given volume element.

The manufacturing operation performed by the at least one virtual agent may be based on one or more of:

i) at least one manufacturing rule relating to the manufacture of the object;
ii) at least one design rule relating to the object to be manufactured; and
iii) at least one boundary condition which defines at least one boundary of a design region within which material forming the object to be manufactured is allowed to exist.

Examples of the aspects described herein beneficially enable an object to be represented, and thus designed, by simulating manufacture of the object from the bottom-up with a starting point of no material. In this way, it is possible to obtain a representation of an object to be manufactured which is based on a definition of a set of real-world manufacturing and/or practical parameters/constraints, rather than any initial, presumed, geometry or aesthetic characteristics. Example embodiments of the examples described herein are advantageous in that object geometries are generated that are inherently “manufacturable” under a predetermined description of the manufacturing processes(s). Furthermore, by removing the need for an initial object geometry, examples described herein may beneficially help avoid design prejudice and/or suboptimal design as a result of poor starting geometry, or design fixation based on a previous design.

It will also be appreciated that example embodiments may be usefully performed in order to evaluate and/or optimise an initial input design drawing based on the manufacturing and design protocols and the at least one boundary condition.

Examples described herein are particularly advantageous in circumstances where an object is to be manufactured by an additive or hybrid manufacturing process. Examples described herein may efficiently facilitate the generation of highly complex object geometries, taking into account key manufacturing and design constraints at an early stage in the design process.

Examples of the invention described herein beneficially allow the simultaneous appraisal of multiple manufacturing constraints. Methods and tools according to example embodiments enable an arbitrary number of manufacturing constraints to be layered within the iterative execution of example methods according to the first aspect, to give a more holistic statement of manufacturability. This statement of manufacturability—which forms the manufacturing protocol required for simulation—is thus used from the outset, during the design stage, to generate a representation of a candidate design of an object to be manufactured, which exhibits a geometry that is inherently manufacturable.

It will be appreciated that the number and detail of the manufacturing protocol and/or design protocol and/or boundary conditions will depend on the level of detail and/or accuracy required for the representation and/or the final manufactured object.

A method according to an example embodiment of the present invention can comprise any combination of the previous apparatus aspects. Methods according to these further embodiments can be described as computer-implemented in that they require processing and memory capability.

The tool according to one or more example is described as configured or operable to carry out certain functions. This configuration or operation could be by use of hardware or middleware or any other suitable system. In preferred embodiments, the configuration or operation is by software.

Thus according to one aspect there is provided a program which, when loaded onto at least one hardware module, configures the at least one hardware module to become the tool according to any of the preceding definitions or any combination thereof.

According to a further aspect there is provided a program which when loaded onto the at least one hardware module configures the at least one hardware module to carry out the method steps according to any of the preceding method definitions or any combination thereof.

In general the hardware mentioned may comprise the elements listed as being configured or arranged to provide the functions defined. For example this hardware may include memory and processing circuitry for the tool.

According to a further aspect there is a provided a method of manufacturing an object comprising:

i) simulating manufacture of the object in a design space to obtain a representation, the simulating being based on one or more of:
a) a manufacturing protocol which defines one or more manufacturing parameters relating to a manufacturing process for manufacturing the object;
b) a design protocol which defines one or more design parameters relating to the object to be manufactured;
c) at least one boundary condition which defines at least one boundary of a design region within which material forming the object to be manufactured is allowed to exist; and
   ii) fabricating the object from the representation.

According to one or more example embodiments, the step of fabricating the object comprises an additive manufacturing process or a hybrid manufacturing process. For example, the object may be fabricated by a method of 3D printing.

For a better understanding of the present invention, and to show how the same may be carried into effect, reference will now be made by way of example to the following drawings in which:

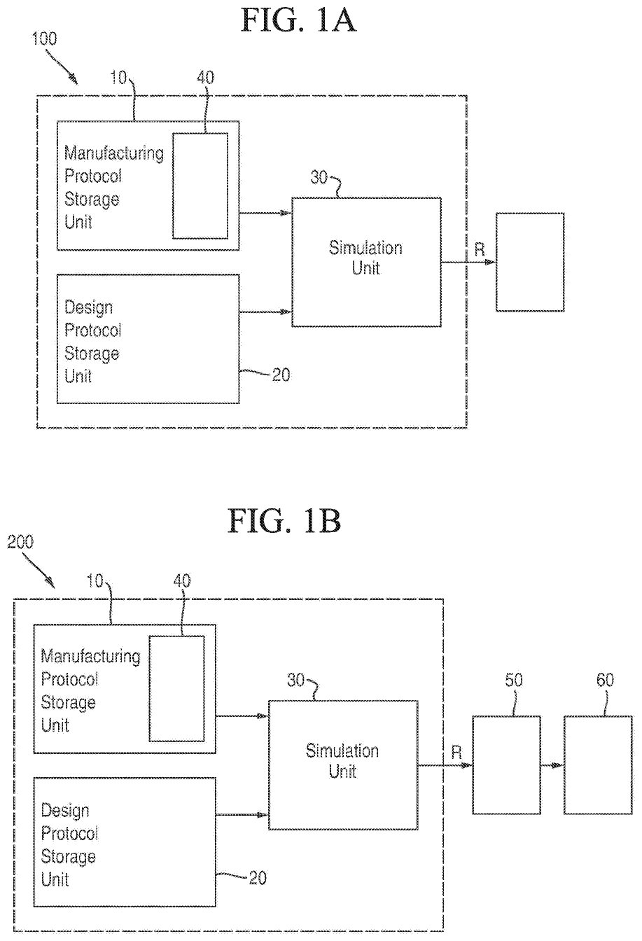

FIG. 1a illustrates a tool for generating a representation of an object to be manufactured according to an illustrative example;

FIG. 1b illustrates an assembly for generating a representation of an object to be manufactured according to a further illustrative example;

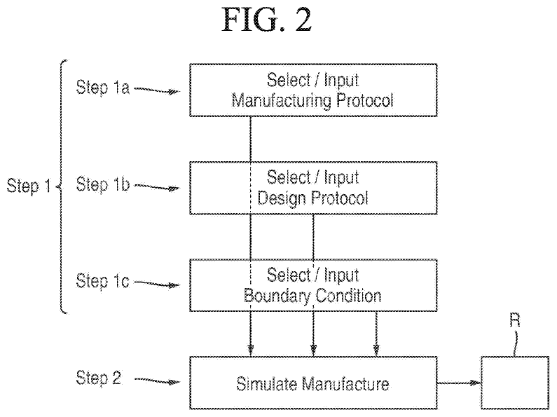

FIG. 2 illustrates a method according to an illustrative example;

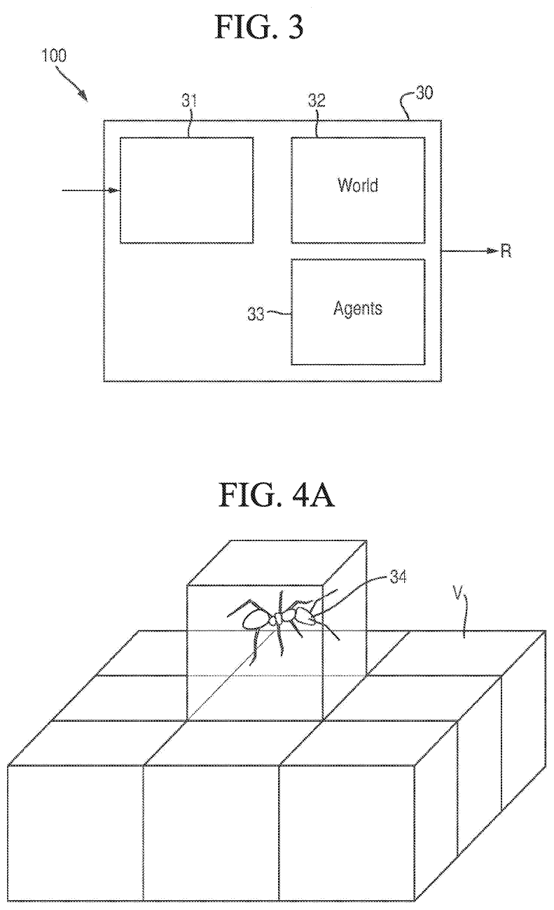

FIG. 3 illustrates a tool for generating a representation of an object to be manufactured according to a further illustrative example;

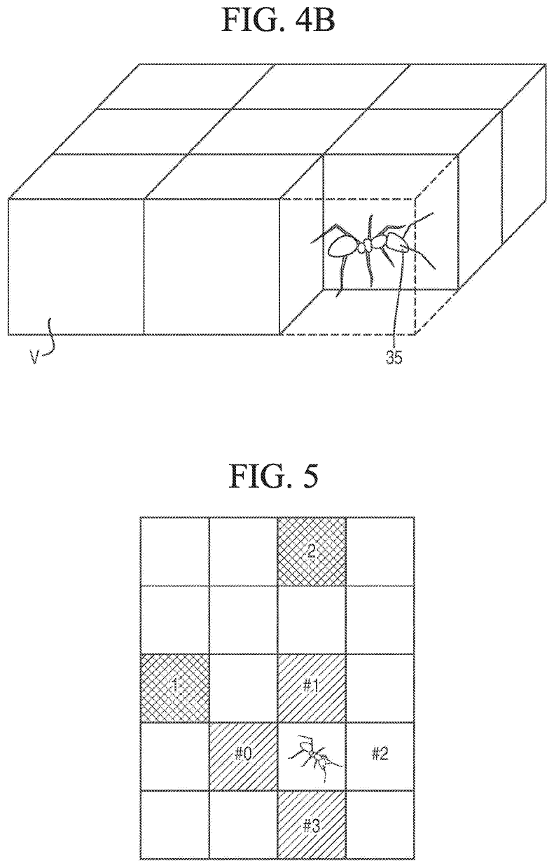

FIGS. 4a and 4b illustrate a part of a design space comprising a plurality of cubic volume elements;

FIG. 5 gives a two-dimensional example of a virtual agent in the vicinity of two pheromone sources (black shading) of strengths one and two;

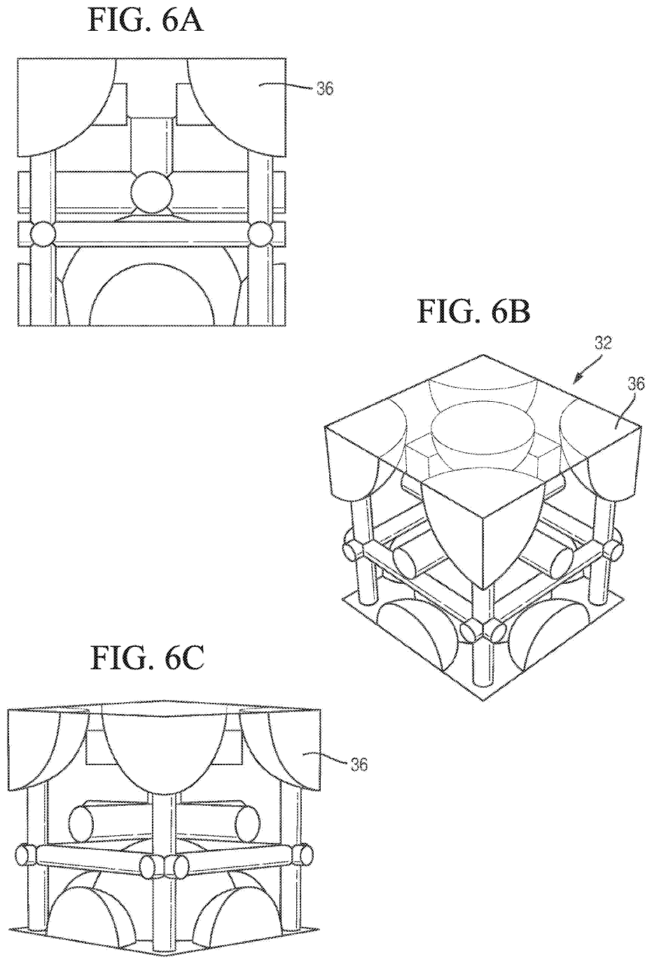

FIGS. 6a, 6b and 6c illustrate from different angles the regions of a design space where material forming the object is forbidden;

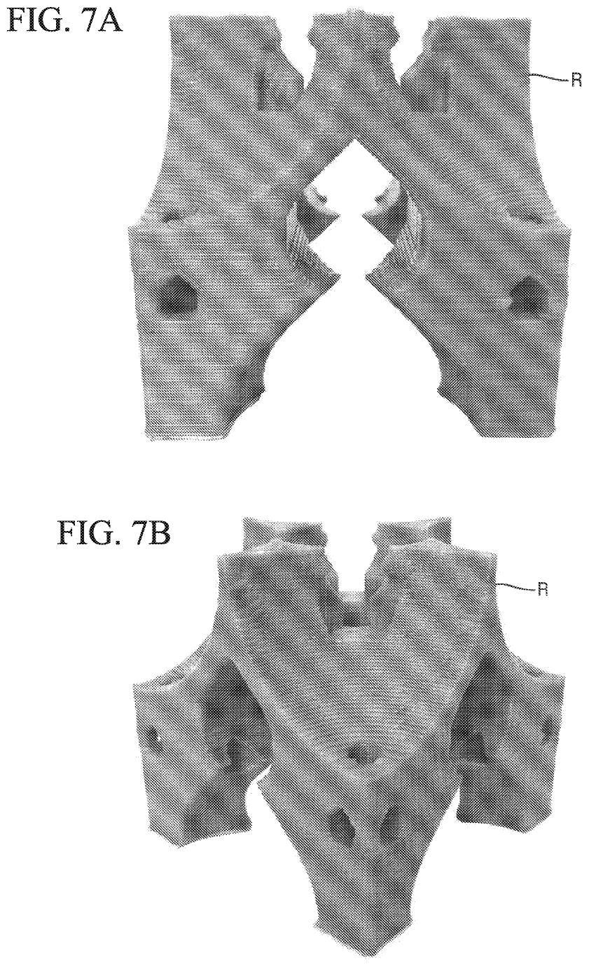

FIGS. 7a and 7b show representations generated according to an example embodiment of the present invention which is based on the boundary conditions illustrated by FIGS. 6a, 6b and 6c;

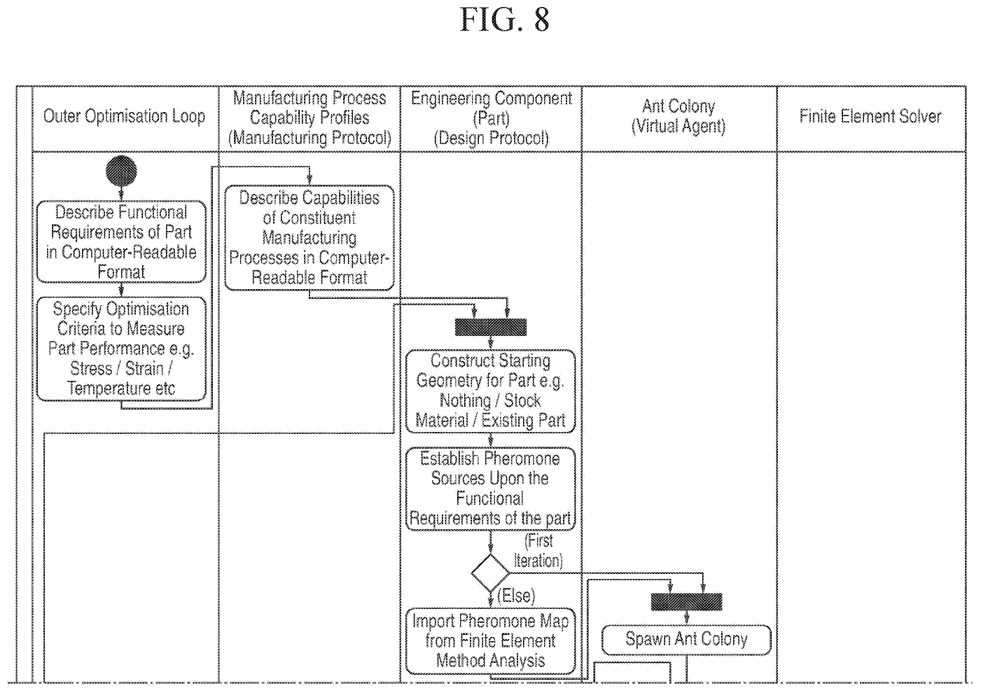

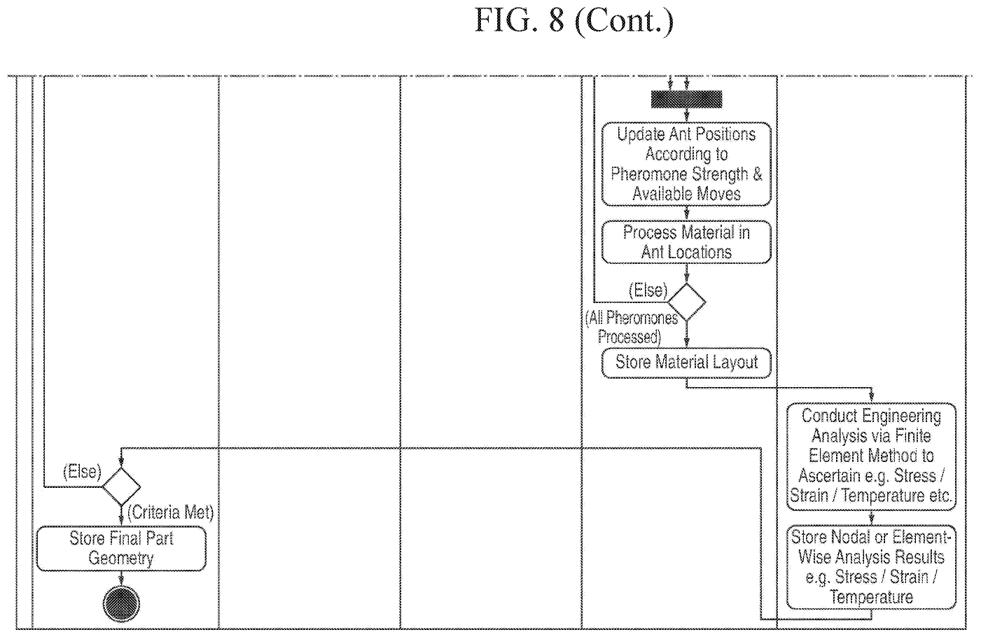

FIG. 8 illustrates a method of simulated manufacture according to a further example embodiment;

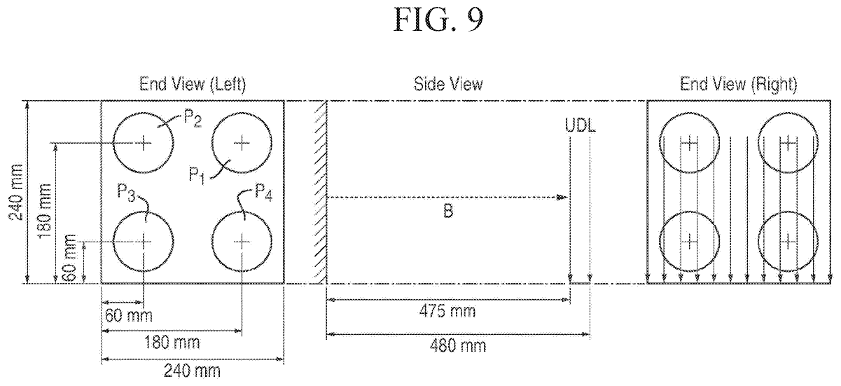

FIG. 9 illustrates a schematic of the starting conditions which form part of the design protocol for a worked example embodiment;

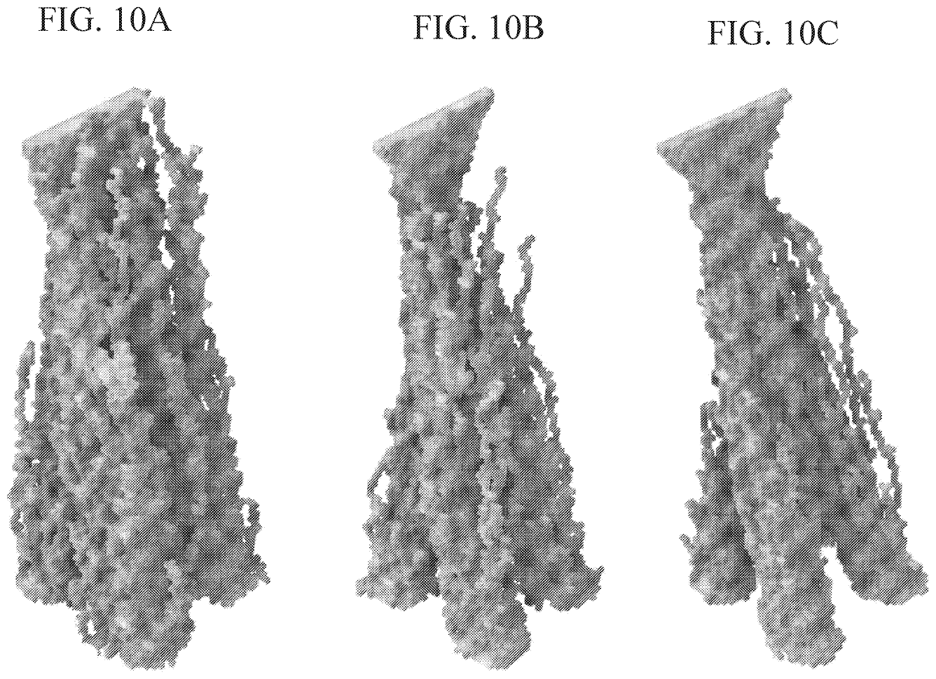

FIGS. 10a, 10b and 10c each illustrates a representation generated by an iteration of a method of simulated manufacture according to the worked example;

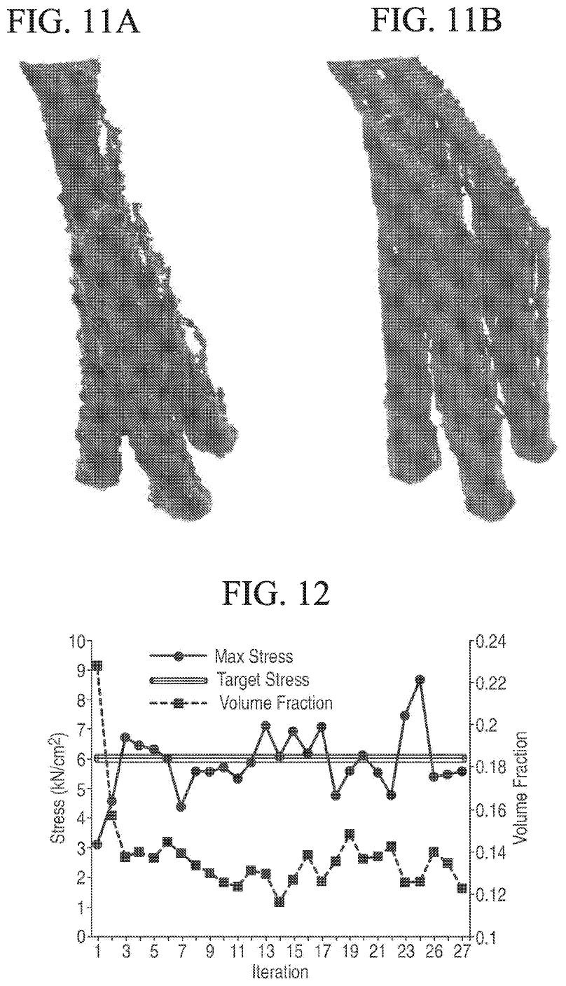

FIGS. 11a and 11b provide a photo of a printed object geometry created from the representation illustrated in FIG. 10c;

FIG. 12 graphically illustrates the progression of the maximum stress and volume fraction of the representation illustrated in FIG. 10c;

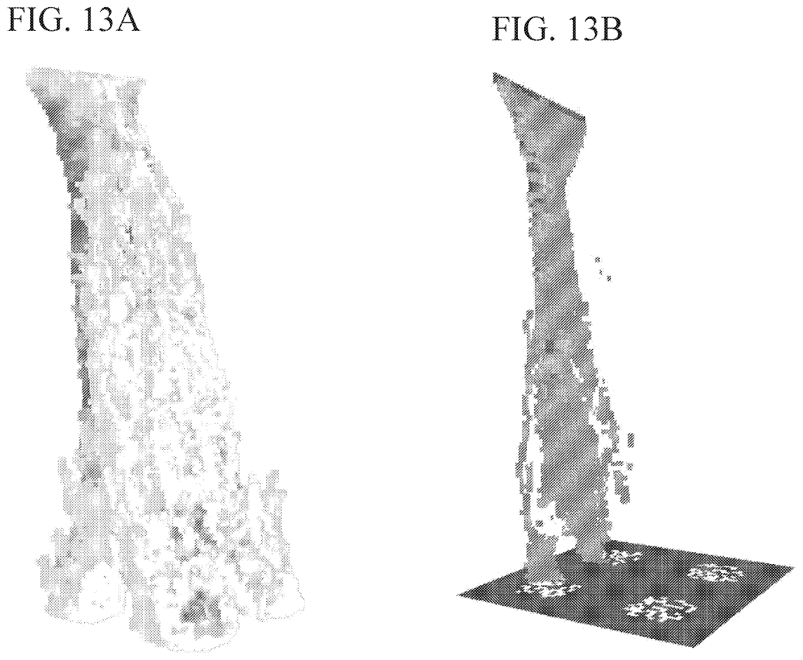

FIG. 13a illustrates a stress distribution created for the representation illustrated in FIG. 10b;

FIG. 13b illustrates the pheromone map corresponding to FIG. 13a.

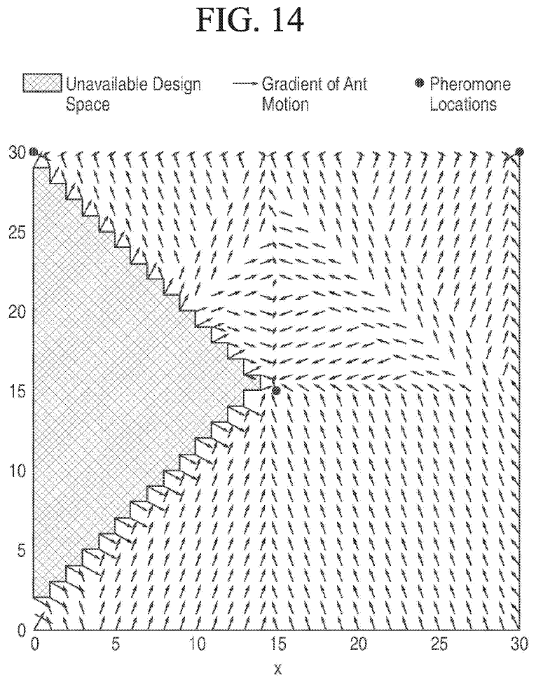

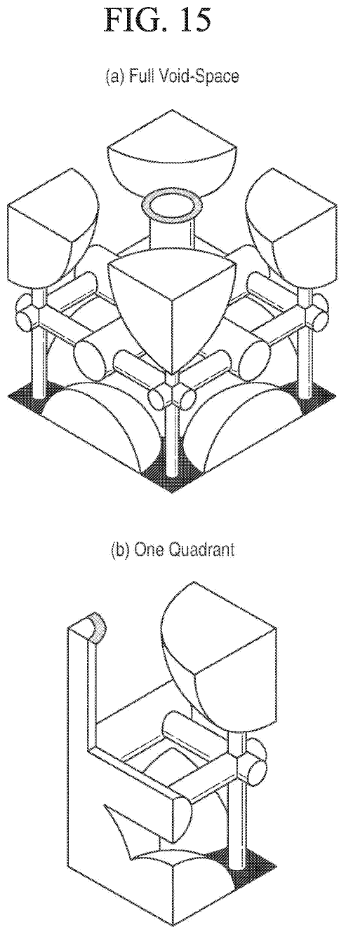

FIG. 14 illustrates a gradient of termite motion affected by pheromones and manufacturing constraints.

FIG. 15 illustrates the ‘void-space’ for proposed design problem.

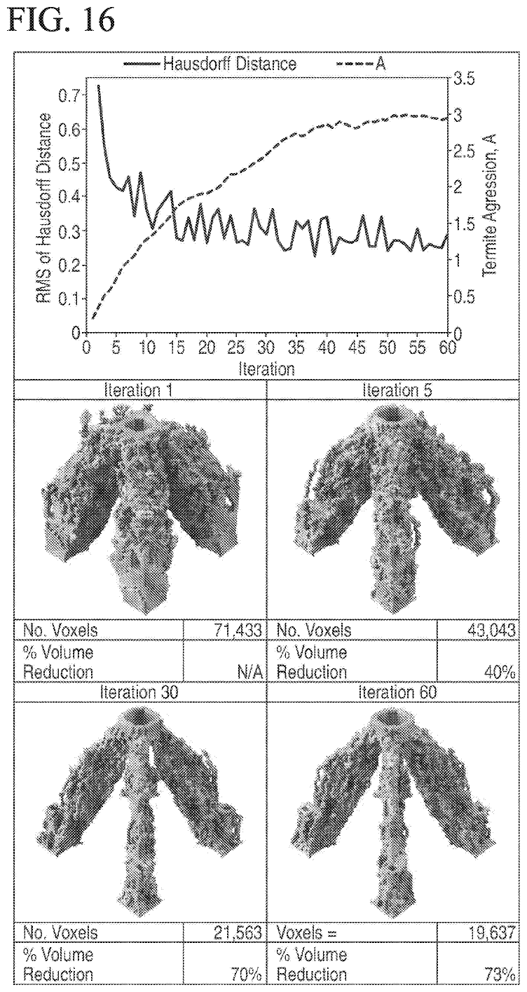

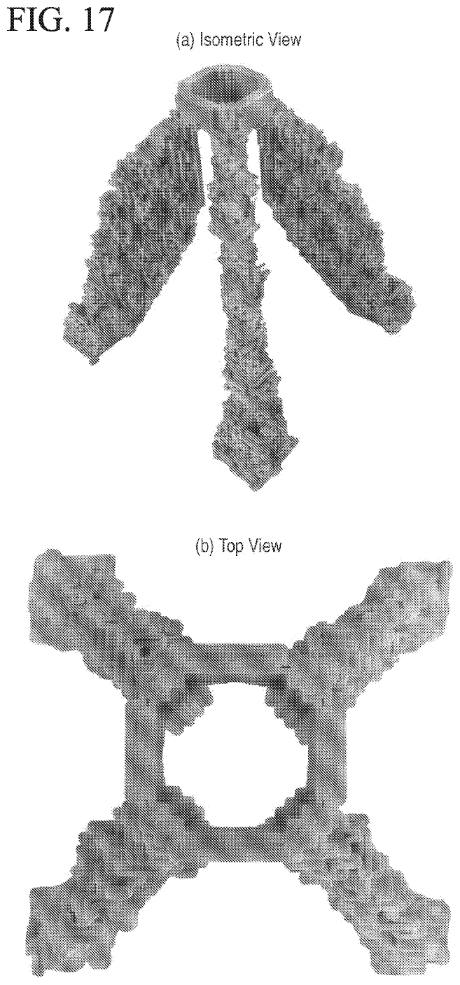

FIG. 16 illustrates a plot of the Hausdorff distance between consecutive design iterations, and a value (Equation 2) for each iteration. Renderings of part geometries are shown in FIG. 17.

FIG. 17 illustrates a printed version of the geometry from the 60th design iteration.

The examples described herein relate to methods and tools for representing an object to be manufactured.

FIG. 1a illustrates the component parts of a tool 100 for generating a representation of an object to be manufactured according to a first example. The tool comprises a manufacturing protocol storage unit 10, a design protocol storage unit, and a simulation unit 30. According to this particular illustrative example, the manufacturing protocol storage unit is provided with a boundary conditions storage unit 40.

As illustrated in FIG. 1a, the tool 100 is operable to generate a representation R of an object to be manufactured based on at least one value or instruction received from the manufacturing protocol storage unit 10, at least one boundary condition from the boundary conditions storage unit 40, and at least one value or instruction received from the design protocol storage unit 20. The simulation unit performs a process of simulated manufacture of the object, based on the received values and/or instructions, and generates a representation R which is output from the simulation unit 30. The representation R may comprise e.g. a drawing of the representation or a computer-readable description of the representation. Additionally or alternatively, the tool may be connected to an electronic display device (not shown) to facilitate a visualisation of the representation within a 2-dimensional or 3-dimensional virtual design space.

FIG. 1b illustrates the component parts of an assembly 200 for manufacturing an object. The assembly comprises a tool for generating a representation of an object to be manufactured according to a first example. The tool comprises a manufacturing protocol storage unit 10, a design protocol storage unit, and a simulation unit 30. The assembly further comprises a display device 50 which allows the representation R and/or the process of simulating the manufacture of an object to be visualised by a user. The assembly further comprises a device 60 for manufacturing a 3D object from the representation R. For example, the assembly may comprise apparatus for 3D printing the representation.

An example method of simulated manufacture according to a further example is illustrated in FIG. 2. The method comprises a step of simulating manufacture of an object for manufacture—i.e. step 2. A first, preliminary, step (which may or may not form a method step according to the present example) involves selecting or inputting a manufacturing protocol to a manufacturing protocol storage unit (step 1a), a design protocol to a design protocol storage unit (step 1b) and at least one boundary condition to a boundary condition storage unit (step 1c).

It will be appreciated that preliminary steps 1a, 1b and 1c may be carried out in any order. It will also be appreciated that one or more of the manufacturing protocol, design protocol and at least one boundary condition may be defined by a user of the tool by e.g. inputting instructions or values prior to simulation. Further, one or more of the manufacturing protocol, design protocol and at least one boundary condition may be selected by a user from a library of protocols provided for the tool. Such a library may be stored within the tool or may be stored remotely, e.g. on a remote server or in the cloud.

FIG. 3 illustrates a tool according to a further example of a tool 100 comprising a simulation unit 30. According to this example, the simulation unit comprises a receiving unit (31) for receiving instructions or values relating to a manufacturing protocol, a design protocol and at least one boundary condition. The instructions or values may be stored locally within at least one storage unit of the tool, or may be received from a remote source.

The simulation unit 30 further comprises a design space—or world—32, within which the object to be manufactured is simulated, and at least one agent 33 operable to carry out the simulated manufacture of the object.

The design space may comprise a virtual design space and the at least one agent may comprise a virtual agent. The virtual design space may comprises a three-dimensional grid. The three-dimensional grid may comprise a plurality of volume elements. The volume elements may divide the design space into a plurality of regular polyhedrons.

The one or more virtual agents may be operable to move within the design space, or virtual world. Each agent is operable, subject to compliance with the various protocol rules received to the receiving unit 31 of the simulation unit 30, to carry out a manufacturing operation at each of the volume elements in order to simulate the manufacture of an object. Thus, each agent is operable to respect the rules or parameters of the manufacturing protocol, the design protocol and the one or more boundary conditions received by the simulation unit. The agent 33 may be considered to comprise one or more instructions, values or rules configured or operable to become a virtual agent for carrying out a defined manufacturing operation.

According to example embodiments, a virtual design space comprising a plurality of volume elements may advantageously comprise a plurality of cubes. In order to create solid geometries without unwanted porosity, it is preferable that material can be added and subtracted at discrete layer heights. It is also desirable to be able to create a regular tiling in the three-dimensional design space. The cube is the only regular polyhedron that provides three-dimensional tiling and, hence, is a preferred volume element of the virtual design space. One or more of the cubic volume elements may comprise more complicated volume shapes within the cube, making the voxel element porous. All volume elements have position and size properties. All volume elements may share a common size or the size of the volume elements may vary across the design space. This size governs the resolution of the part geometries that are created. Depending on the degrees of freedom exhibited by a manufacturing process, each of the six sides of the cube can be used for traversal and material processing during manufacture.

A plurality of virtual agents or “ants” may be provided to create a colony of ants. Each ant is able to travel and perform work within the virtual space. Thus, according to at least one example, an agent known as an additive ant is operable to add material to fill a given volume element. An agent known as a subtractive ant is operable to remove material from a given volume element.

FIG. 4a illustrates a part of a design space according to one example comprising a plurality of cubic voxels V and an additive ant 34 for adding material to the design space. FIG. 4b illustrates a part of a design space according to one example comprising a plurality of cubic voxels V and a subtractive ant 35 for removing material from the design space.

A virtual agent may move through the virtual design space, subject to any geometrical constraints defined in the manufacturing or design protocols or by the one or more boundary conditions. Thus, a virtual agent can be considered to move within a permitted design region of the virtual design space.

According to one or more example, a virtual agent may follow a random, weighted-random or predetermined path. Alternatively, according to one or more example, a virtual agent may follow movement instructions or rules. The movement of an agent may be described as taxis movement, whereby each agent moves in response to a stimulus or source. This may be achieved, for example, by means of a “pheromone map” which provides instructions for the movement of each agent.

A pheromone map can be considered to represent an intensity field that is strongest at some origin and the decreases in intensity as you get further away from the origin. Many such intensity fields or maps may be superposed to capture the influence of multiple sources.

According to one or more examples, wherein the simulation unit comprises a virtual world comprised of a plurality of cubic volume elements, an ant is preferably positioned at the centre of the cubic volume, but can be orientated to face each of the six faces. The ant may follow a taxicab motion within the volume element grid, thus potentially moving up, down, forward, backwards, left and right. The orientation of the ant may be used to change direction within the world, but may also be used to change the direction in which the ants process material. As such, depending on the degrees of freedom of a particular manufacturing process, not all orientations can be used to process material. For example, in the case of simulating manufacture by means of three-axis machining, the axis of the cutting tool must always be parallel to the Z-direction. Thus, this constraint must be conveyed to the simulation unit and respected during the simulated manufacture.

A colony of ants may be governed by a so-called ‘queen’. The queen may be operable to create ants on the initial build plate surface(s) and/or to destroy ants that have failed to either move or process for a fixed number of time-steps. The queen may hold a pheromone map and may be operable to issue movement instructions for each worker-ant as well as commands for each ant to perform its particular manufacturing operation.

Thus, according to one or more examples, ants can be considered to roam throughout the virtual world, checking with every move to see if they can perform their designated manufacturing operation. Much like ants in nature, the ants may follow pheromone trails which become stronger or weaker depending on the need for a particular manufacturing process. The strength of the pheromone relates directly to the statistical probability of a particular ant performing a manufacturing process in that location (random draw). If it is deemed that an ant should process, it must then check to see if it is in contravention of any of the rules of manufacturability (e.g. don't attempt to deposit new material that is not attached to any pre-existing material).

The motion of all ants is preferably governed by the same mechanism. Let D_{(i,j,k)} denote the distance of the i^{th} ant from the j^{th} pheromone source, given that the ant makes the k^{th} move.

D_{(i,j,k)}=∥vⱼ−(vᵢ+vₖ)∥₁ (1)

where vᵢ is position of the i^{th} ant, vⱼ is the position of the j^{th} pheromone source and vₖ describes the vector movement of the k^{th} move. Here, ∥x∥₁ is the taxicab norm of the vector x. This distance quantity is then used to calculate the total strength of all pheromone scents acting on the i^{th} ant once it has made the k^{th} move, which shall be denoted γ_{i,k}.

$${γ}_{( i , k )} = {\sum }_{j = 0}^{J} \frac{{ρ}_{k} {s}_{j}}{1 + {D}_{( i , j , k )}} \qquad ( 2 )$$

The parameter, ρₖ, denotes the presence of absence of material at the ant's position once it has made the k^{th} move. It is set to zero if material is absent and set to one if material is present. The parameter, sⱼ, is the strength of the j^{th} pheromone source at its origin, and J is the total number of pheromone sources minus one (zero indexing). The value γ_{(i,k)} is finally used to calculate the probability of the i^{th} ant making the k^{th} move from its current location.

$${P}_{( i , k )} = \frac{{γ}_{( i , k )} {r}_{i , k}^{A}}{{\sum }_{k = 0}^{K} {γ}_{i , k} {r}_{i , k}^{A}} \qquad ( 3 )$$

These probabilities may then be used to select which of the K total possible moves, the i^{th} ant makes via a random draw. In (3), r_{i,k}^{A} is the ascending rank for the increase in pheromone strength for each of the K possible moves, raised to the power A. By increasing A, the likelihood of the i^{th} ant making a move in the direction of the strongest pheromone scent increases substantially. Therefore, when pheromone sources reflect the distribution of stress in the part, ants are more likely to deposit in the vicinity of the high-stress regions. A is set in accordance with the principles of proportional control:

$${A}_{n + 1} = {K}_{p} ( \frac{{F}_{y}}{{s}_{f}} - {F}_{max} ) + {A}_{n} \qquad ( 4 )$$

Here, Aₙ₊₁ is the exponent used in the next iteration, K_{ρ} is a proportional gain, F_{y} is the yield stress of the material, s_{f} is a factor of safety, Fₘₐₓ is the maximum stress arising in the FEA and Aₙ is the exponent in the current iteration.

Once the ant has moved, it is then determined whether the ant should perform its manufacturing process. This is again a matter of probability. For an additive process, (2) and (3) are reused with modification. The parameter γ_{(i,k)} is replaced with σ_{(i,k)}, which is a measure of the need for the i^{th} ant to perform a process having made the k^{th} move.

$${σ}_{( i , k )} = {\sum }_{j = 0}^{J} \frac{( 1 - {ρ}_{k} ) {s}_{j}}{1 + {D}_{( i , j , k )}} \qquad ( 5 )$$

This is then used in a similar manner to (3) to calculate the probability of performing a manufacturing operation in situ. The exponent, A, is calculated as in (4).

$${P}_{( i , k )}^{*} = \frac{{σ}_{( i , k )} {r}_{i , k}^{A}}{{\sum }_{k = 0}^{K} {γ}_{i , k} {r}_{i , k}^{A}} \qquad ( 6 )$$

FIG. 5 shows a two-dimensional example of an ant in the vicinity of two pheromone sources (black shading) of strengths one and two. The four possible moves for the ant are denoted using the ‘#’ symbol. Grey shading is used to show regions that currently have material in situ. Using (1)-(3), the percentage chance of the ant moving to positions #0, #1, #2 or #3 are 12.57%, 86.79% 0% and 0.64%, respectively, when A is set to 4. This shows the preference towards the intuitive move towards the pheromone sources.

According to one or more examples embodiments described herein, the manufacturing protocol specifies parameters relating to the intended manufacturing process. For example, the manufacturing process protocol may comprise at least one value, instruction or rule which arises as a consequence of e.g.: a tool accessibility constraint, the avoidance or minimisation of any support structure required by the object, and the avoidance or minimisation of so-called “overhanging features”.

For example, in the case of an intended additive manufacturing process, the manufacturing process protocol may specify regions of access that are required for material deposition. In the case of an intended subtractive manufacturing process, the manufacturing process protocol may specify regions which must be kept clear of material forming the object to allow for tool accessibility.

Example manufacturing rules include:

1. Support: If adding material, there must be sufficient supporting material (previously added) beneath the point at which material is about to be added;
2. Line of sight: If adding or subtracting material, there must be clear line of sight to the point of processes i.e. no pre-existing material that the e.g. tool, laser, electron beam or high-speed powder flow from a nozzle must pass through in order to process at the desired location.

The list of rules forming the manufacturing protocol may continue ad-infinitum, depending on the level of knowledge or detail required. A more comprehensive set of rules may include:

1. A volume element of material may be added if there is sufficient support material beneath it.
2. If the additive process can accommodate an overhang of 45° to the build direction before requiring support structure, there must be material directly beneath or diagonally beneath the newly added material in the direction of processing.
3. There must be line-of-sight access to the processing location in the direction of processing. This can be represented as a cylindrical column of empty space above the position of the new material, extending to the edge of the design space. This can be an arbitrary geometry to better reflect the hardware being utilised.
4. Both additive and subtractive processes must avoid processing already processed material i.e. don't add material where material already exists and do not attempt to cut empty space.
5. A subtractive process should not divide a single workpiece into multiple workpieces. This can be checked using a depth-first search of a tree structure which defines all existing cubes of material and their connectivity. If this search identifies multiple connected tree structures, the part has been divided. It should be noted that connectivity can be established through the build plate, to permit the simultaneous construction of multiple columns that are later joined.

The manufacturing protocol and/or the design protocol may comprise one or more instructions, values or rules which define at least one property of a material that is to be used during the manufacture of the object. The material properties may relate to the mechanical properties of the material e.g. the strength, elasticity, malleability, stiffness, ductility of the material. Alternatively or additionally the material properties may relate to the chemical, electrical, magnetic, optical or thermal, properties of the material, for example.

According to one or more examples described herein, the design protocol may specify one or more design parameters relating to the object to be manufactured. For example, the design protocol may include a definition of an initial starting geometry of the object to be manufactured and/or a definition of one or more required attributes of the object.

Thus, the starting geometry may define the dimensions and/or shape and/or location within the design space of one or more build-plates onto which the representation is built. Thus, the simulated manufacture of an object can be considered to comprise the creation of object geometries by adding material to the build plate.

The at least one attribute of the object to be manufactured may include a description or definition of, for example:

one or more holes that are required e.g. for a fastener;
one or more flat surfaces required for location and mating to other objects;
inlet and/or outlet ports required for fluid flow;
the geometry of peripheral objects or subsystems;
and the required strength of the object or the engineering requirements of the object based on e.g. a description of loads and bearing forces that may act on the object to be manufactured.

According to one or more examples described herein, the boundary conditions define at least one boundary of a design region within which material forming the object to be manufactured is allowed to exist. In particular, the boundary conditions may define a) one or more regions where material forming the object is required and/or b) one or more regions where material forming the object is forbidden (e.g. a void).

An example of the boundary conditions that may be supplied for a method of simulated manufacture according to an example embodiment of the present invention can be appreciated by reference to FIGS. 6a, 6b and 6c. FIGS. 6a, 6b and 6c illustrate from different angles the regions 36 of a design space 32 where material forming the object is forbidden. Specifically, the grey areas illustrate voids within the design space which may arise as a consequence of e.g. tool accessibility required for manufacture.

It will be appreciated that an instruction or rule which forms part of a manufacturing protocol or the design protocol may specify a target that has no defined limit, for example “reduce mass as much as possible”.

FIGS. 7a and 7b show representations generated according to an example embodiment of the present invention which is based on the boundary conditions illustrated by FIGS. 6a, 6b and 6c. Specifically, FIG. 7a provides a representation R of the resultant object geometry viewed from the front, and FIG. 7b shows a perspective view of the representation.

According to one or more examples, a representation obtained by simulated manufacture may be subsequently subject to additional processing techniques or analysis. For example, a representation may be sent to a finite element analysis (FEA) tool or unit which is operable to simulate the loading condition placed on the object.

Finite element analysis or the finite element method (FEM) is a known numerical technique for finding approximate solutions to boundary value problems for partial differential equations. It subdivides a large problem into smaller, simpler parts that are called finite elements. The simple equations that model these finite elements are then assembled into a larger system of equations that models the entire problem. FEM then uses variational methods from the calculus of variations to approximate a solution by minimizing an associated error function.

A FEM may be used to determine the stress and strain within one or more regions of the object's geometry. This information may then be passed back to a simulation unit according to an example embodiment for a further iteration of simulated manufacture, which utilises the loading data obtained from the FEA. In this way, it is possible for virtual agents operable to carry out the simulated manufacture to be drawn towards area of high stress and to avoid areas of low stress. This means that areas of the object's geometry that were previously too weak are likely to get extra support/material, whereas areas of low stress tend to become thinner or disappear altogether.

FIG. 8 illustrates a method of simulated manufacture according to a further example embodiment. Specifically, FIG. 8 gives an example for the integration of a finite element method solver to create closed-loop for the creation of object representation. In the first instance, an object is designed by a system according to an example embodiment, considering only the initial inputs arising in the Design Protocol(s), Manufacturing Protocol(s) and Boundary Condition(s). Once the initial inputs are satisfied by a particular arrangement of material, a computer-readable description of the created representation is passed to the Finite Element Solver. Here, the load cases and constraints are applied to the part, and parameters of interest are computed numerically e.g. stress, strain or temperature etc. These parameters of interest are then included in an updated Design Protocol, where areas of interest (e.g. high stress) become new requirements that the subsequent object design must satisfy. Iteration through this closed-loop may continue ad infinitum, or until a stopping criterion is satisfied.

Examples described herein may be considered to be a closed loop system. The result of iterating through this closed loop is the design of an object that makes economical use of material to meet the attributes required for the object. In essence, material is only placed where it is required.

FIGS. 9, 10 and 11 provide illustration of a worked example according to an example embodiment. It will be appreciated that the specific dimensions provided in FIG. 9 are for the purposes of example only.

This example is for a bracket that extends away from a wall or other mounting surface, supporting a cantilevered load at a fixed distance from the wall. Ants are spawned on the attachment plate to the wall in four circular locating regions p1 to p4. A schematic of the starting conditions which form part of the design protocol set-up is given in FIG. 9. The build direction B of the component is also shown.

According to this example, the simulated manufacture was executed for a total of 27 iterations (approximately 2 minutes per iteration) of generative geometry creation and subsequent finite element analysis to create stress-fields. Renderings of the resulting geometries for the first, eighteenth and final iterations are given in FIGS. 10a, 10b 10c respectively. Each of these geometries can be considered to comprise a plurality of interconnected volume elements. The maximum stress and volume fraction for the parts are as follows:

Target Stress
6.00 kN/cm

Max Stress
(a) 3.08 kN/cm²
(b) 4.74 kN/cm²
(c) 5.54 kN/cm²

Volume Fraction
(a) 0.228
(b) 0.135
(c) 0.122

From inspection of the images and the statistics given above, several behaviours are clear. Firstly, the load-bearing end of the cantilevered structure has been successfully connected to the mounting plate. Secondly, as the iterations progress, there is an obvious tendency towards thinning the structures and the establishment of separated ‘legs’ extending from the mounting plate. Two photographs are shown in FIG. 11. Specifically, FIG. 11a shows printed the object geometry created from FIG. 10c and another example for the same set-up but supporting half of the specified load. Both parts uphold the manufacturability criterion defined in the manufacturing protocol of avoiding support structure in the specified build direction.

The progression of the maximum stress and volume fraction of the designed geometries is shown in FIG. 12. This graph also shows the target maximum stress for the design. The volume fraction clearly drops rapidly in the first few iterations and then stabilizes between 0.12 and 0.13. These values show significant light-weighting opportunities are available through the performance of simulated manufacture. The maximum stress experienced by the parts initially increases towards the target stress and then oscillates around the target value. FIG. 13a illustrates the stress distribution may created for the 18^{th} iteration, where darker shading indicates regions of greater stress, and FIG. 13b illustrates the corresponding pheromone map used to instruct the movement of the virtual ants performing simulated manufacture. Care should preferably be taken to avoid selecting geometry that falls marginally above the designed maximum stress threshold. As such, it is important to compare both volume fraction and maximum stress when selecting a geometry.

Simulated manufacture as in this example facilities the rapid generation of multiple, viable geometric representations.

Embodiments of the present invention include a generative multi-agent design methodology for additively manufactured parts inspired by termite nest building.

The geometrical complexity available through additive manufacturing processes requires new tools to help designers maximise its advantages. A termite colony can construct highly complex nests that are optimised for thermoregulation and ventilation. The simple individual behaviour of these termites leads to highly intelligent colony behaviour, allowing nests to be simultaneously designed, optimised and produced. By mimicking termite behaviour, this research has led to a new design methodology using multi-agent algorithms that simultaneously design, structurally optimise and appraise the manufacturability of parts produced by additive manufacturing. A case study demonstrates the generative design of lightweight parts using the multi-agent system.

### 1. Introduction

Additive manufacturing (AM) processes promise to unlock unprecedented levels of design freedom via layer-wise manufacture. This freedom could lead to step-changes in the complexity and performance of parts and products. However, the question remains—are we equipped to comprehend and leverage this level of complexity and design freedom?

The ability to manufacture almost any shape with hierarchical complexity (macro geometry, meso-material properties such as lattices, and custom microstructures or metallurgies) means that the design space for AM is vast. Furthermore, complex relationships exist between part geometry and part ‘manufacturability’. For example, the orientation of the part with respect to the build direction can significantly influence material and energy usage. Also, the build-up of residual stress within a part is often difficult to predict, which can result in costly in-build or in-service failures.

In 2008, a call was made for new tools to support designers as they pursue optimal designs within highly complex design spaces. This is increasingly poignant in connection with industrialised AM. Successful design for AM (DfAM) relies on an increasing overlap between engineering design, materials science and manufacturing. One reason for this is the lack of opportunities for human intervention during the manufacturing process. The pressing need to consider the effects that design changes have on downstream processes requires engineering with AM to be more integrated or even concurrent. These notions have been explicitly identified in the 2016 CIRP Annals Keynote on Design for Additive Manufacturing (DfAM), stating:

“The coupling between the design, representation, analysis, optimisation, and manufacture still needs to be resolved.”

The aim is to address this statement directly by taking inspiration from nature, which has proven to be a fruitful source of inspiration in engineering design. Termite nests are highly complex and can be optimised for ventilation or thermo-regulation. This is achieved without any intelligible architectural oversight. The existence of termite nests is testament to the fact that they are inherently ‘manufacturable’. A design method is presented that mimics the behaviour of termites as they build their nests, to concurrently design, structurally optimise and appraise the manufacturability of AM parts.

### 2. Background

As industry aims to increasingly utilise AM, there is a risk that the design process will not be objective or exploratory. Prior experience with traditional manufacturing processes, subconscious bias or prejudice towards a particular aesthetic or layout, and the risk of design fixation may all compromise the objectivity of an AM part design. This may be heightened by time consuming developmental and optimisation cycles.

Throughout the 1970-80s, traditional manufacturing processes (e.g. machining or casting) benefited from the introduction of Design for Manufacture and Assembly (DfMA). Since the emergence and proliferation of AM, research has tried to adapt the DfMA guidelines to accommodate AM processes; however, these have struggled to capture the integrated nature of designing parts for AM. Consequently, a body of research is amassing in the use of more flexible tools that aim to search more broadly through large design spaces, or target optimal designs.

Generative design tools that create concepts from requirements, constraints and goals are viewed as one way to be more exploratory and objective. Autodesk describe four types of generative design tools that are emerging in field of DfAM: form synthesis, lattice and surface optimisation, topology optimisation and trabecular structures. These methods may be regarded as design-by-search, or design-by-optimisation. However, this mathematical approach often fails to incorporate human interaction and oversight throughout the design process. Recent research has tried to address this issue via human-computer interaction within generative design tools.

It is the inventors' contention that although generative design methods are emerging as a popular approach for DfAM, they too are currently failing to couple design, representation, analysis, optimisation and manufacture. As such, the inventors have developed a new, multi-agent generative design tool. The system receives a description of the part's functional requirements and the available manufacturing capabilities as inputs. Many agents, or “termites”, generatively construct geometries by depositing material; always adhering to the design and manufacturing constraints. Integration with a finite element solver makes this a closed loop system, whereby the termites' behaviour is altered according to e.g. stress within the part. The governing dynamics of the system and its ability to convergence upon a final part concept are discussed.

### 3. The Governing Dynamics of the “Termite” Colony

Termites move throughout a three-dimensional world, constrained by “taxicab geometry” (i.e. no diagonal movements). This results in six possible directions of motion and the direction of each termite is determined using a random draw from these six options. Additionally, each termite may only move by one unit of length per move. To steer the subgroups of the colony to areas of interest, the probability of a termite making a certain move is manipulated according to two criteria: (i) The gradient of the pheromone field at each termite location, and (ii) the presence or absence of material in all possible subsequent locations for each termite (i.e. after their next move).

3.1. Behaviour Resulting from “Pheromones”

“Pheromones” are used to direct the termite colony. Termites are encouraged to move themselves, and build material towards, pheromone sources. The need to attract termites is initially to connect all part features using a single expanse of material. In addition, the integrated finite element analysis (FEA) converts stress magnitude into pheromone intensity, thereby encouraging termites to increase the amount of material in highly-stressed regions. Each pheromone source results in a field that diffuses across an n-dimensional space in which the part exists. At a given position, this field has an intensity, which relates to the proximity of the pheromone source. The intensity of the pheromone field at a given location is established via the summation of all individual pheromone effects. The intensity perceived at the location of the ith termite is:

$$\begin{matrix}{γ}_{( i , k )} = {\sum }_{j = 0}^{J} \frac{C {s}_{j}}{1 + {D}_{( i , j , k )}} & ( i ) \\ {P}_{( i , k )} = \frac{{γ}_{( i , k )} {r}_{i , k}^{A}}{{\sum }_{k = 0}^{K} {γ}_{i , k} {r}_{i , k}^{A}} & ( ii )\end{matrix}$$

sj is the strength of the jth pheromone at its origin. D(i,j,k) is the taxicab distance from the ith termite to the jth pheromone source, once it has moved in the kth direction.

D_{(i,j,k)}=∥vⱼ−(vₖ+vₖ))∥₁ (iii)

In an n-dimensional world, the kth direction corresponds to the vector forming the kth row matrix, v:

$$v = [ \begin{matrix}{I}_{n \times n} \\ - {I}_{n \times n}\end{matrix} ] \qquad ( iv )$$

Termites may do one of two things, namely move to a new location or process material; first they move and then they process. The governing equations (1 and 2) behave differently depending on whether an ant is moving or processing. This is controlled by the conditional nature of the parameter, C:

$$C = \{ \begin{matrix}{ρ}_{k} , a moving termite \\ ( 1 - {ρ}_{k} ) M , a processing termite\end{matrix} \qquad ( v )$$

Here, ρₖ is a binary operator that identifies whether material exists in the position of the termite once it has either moved or processed in the kth direction. If material exists, it is set to one. The parameter, M, encompasses a set of manufacturability checks. These are discussed in Section 3.2. The elegance of, C, is that it represents the perceptive capabilities of the termites; telling them what is within their surroundings and, therefore, what their next available actions are.

The tendency of a termite to perform an action in the kth direction is given by the instantaneous gradient of the pheromone field ∇γ_{(i,k)}. This is calculated numerically using central and one-sided differencing. It is not guaranteed that a termite will perform an action in the direction of steepest descent. Instead, this is controlled by a random draw. The probability of performing an action in the kth direction is defined by Equation (ii). Each probability is multiplied by a weight, which depends on the rank of the kth move and the magnitude of the termite's “aggression,” A. The A value is updated using an appropriate control law (proportional control). This determines whether the termites' behaviour is direct or exploratory.

### 3.2. Behaviour Resulting Manufacturing and Design Constraints

Termites are attracted towards high intensity pheromones. The actions the termites perform to reach the pheromones are dependent on manufacturing and design constraints for a particular problem. As seen in equations (i) and (v), termites only consider actions in a given direction if, C, is satisfied i.e. material is present in the kth direction. For a termite to process material in a kth direction, material must be absent as well as the parameter, M, being equal to one. M is a set of Boolean operators representing all of the manufacturing constraints that must all be satisfied. The multiplication of each term ensures that M only has a value of one when all checks return a value of one. Any value of mₙ will be zero if it fails its manufacturing check. Hence, if any of the manufacturing checks fail, M will also be zero. This prevents the termite from processing material in that direction.

M=m₁×m₂×m₃× . . . mₙ (vi)

The list of manufacturing checks can be as detailed or general as is required. Some examples of manufacturing checks can be defined as follows: Is there material? Is there sufficient support material? Is there tool accessibility? Is material allowed? Minimum feature size? Feature aspect ratio?

By rigidly following these rules, termites are attracted towards pheromones and process material where needed but only in a way that simulates manufacture according to the rules set by the manufacturing constraints. FIG. 14 illustrates the intensity field created by the pheromones, whilst also accounting for the manufacturing checks. Material is forbidden in the dark grey area, forcing termites away from this region.

### 3.3 Destroying Pheromone Sources

The need for a termite to directly deposit material upon a pheromone source reduces as the intensity of the pheromone reduces. This means that regions of, say, high stress require material to be placed exactly upon the origin of the associated pheromone source. In contrast a very weak pheromone source may be regarded as being ‘satisfied’ if material is placed within its vicinity. What motivates this behaviour is the desire to place material where it is strictly necessary; much like existing topology optimisation techniques. The conditions for removing a pheromone source are given by the inequalities in (vii).

∥vᵢⱼ∥≥0,sⱼ≥0,sⱼ<1−cₖᵢₗₗ∥vᵢⱼ∥₁² (vii)

### 4. Results: Converging on a Final Design

The termites optimise a given design problem with respect to various objectives. An example design problem might include an envelope where material is permitted, a loading condition, and a more general objective to reduce the mass of the part. A fictional design problem is described in FIG. 15, which shows three things. Firstly, solid white cylinders and spherical sections show regions in which material is not permitted (void-space). These might represent external subsystems that cannot be relocated, or access for maintenance tooling or wiring. In this example, the void-space is intentionally complex. Secondly, the black shading denotes the build plate and the build direction is normal to this surface. Finally, the hatched shading denotes a surface that will have a uniformly distributed compressive load applied to it, acting towards the build plate.

A feedback loop is established between the termite colony and a finite element solver. This allows closed-loop design iteration, where the termite colony outputs the current geometry and the FE solver converts this into a quantitative performance measure. This loop may continue ad infinitum, or until a stopping criterion is fulfilled. Stress values are fed back to the termite colony, where they are then converted into new pheromones, with intensity proportional to the stress magnitude.

To demonstrate that the system converges upon a final part geometry, two observation metrics are used. The first of these is the Hausdorff distance (dH), which is taken as a measure of the similarity between the part geometries created in consecutive iterations of the algorithm. Here, the difference between the ith part geometry mesh (set Y) is compared against the ith−1 reference mesh (set X). The dH between the two meshes is calculated based on the sets X and Y using (viii)

$${d}_{H} ( X , Y ) = max \{ {sup}_{x ∈ X} inf d ( x , y ) , {sup}_{y ∈ Y} {inf}_{x ∈ X} d ( x , y ) \} , \qquad ( viii )$$

Here, ‘sup’ and ‘inf’ are the supremum and the infimum, respectively. Consecutive meshes with a small dH between them are considered to be more similar than those with larger values. The convergence of the dH over a total of 60 iterations is shown in FIG. 16, where the dH is shown to reduce from 0.73 and settle at approximately 0.3. In addition to the dH, the ‘aggression’ of the termites (A, Equation (ii)) is also plotted. This value is initiated at 0.2 and then increases and eventually settles at approximately 3 over the course of the 60 iterations. This is in accordance with the proportional control law employed to set this value.

To demonstrate that the geometry from the 60th design iteration is inherently ‘manufacturable’ without support, the geometry was additively manufactured using an Ultimaker 2 Extended+ FDM printer using PLA (see FIG. 17).

### 5. Discussion

The CIRP community has highlighted the need for a greater coupling between design, representation, analysis, optimisation, and manufacture in association with AM. A method has been introduced for achieving this coupling via a generative, agent-based design tool. This tool migrates away from designing parts by drawing them, and moves towards designing parts by simulating their manufacture within a closed-loop design optimisation. This has demonstrated that parts designed this way are: (a) able to satisfy the functional requirements, such as load-bearing capability and avoidance of specific regions; (b) achieve an overarching design objective, such as reducing part mass; and (c) converge upon an overall volume and shape.

Given a fictional design problem (Section 4), the system designed a part that did not exceed the maximum permissible stress under compressive loading; 5.98 MPa compared with 6 MPa. The final part did not violate any of the spatial constraints imposed by the void space (FIG. 15), and could also be manufactured without any supporting material. The final part (60th iteration) had a voxel count of 19,637 voxels. The total available volume in which material could exist (bounding box minus void-space volume) was 159,997 voxels. This represents a volume reduction of 88% when compared to the largest permissible geometry.

One of the advantages of the proposed system is that it concurrently designs, structurally optimises and appraises the manufacturability of a part. Furthermore, the number of design and manufacturing constraints and requirements can be increased or decreased at the user's discretion. The parts that are designed by the system are inherently ‘manufacturable’ under the given description of the process. It is proposed that more detailed descriptions of the manufacturing capability would permit greater confidence in the successful manufacture of the part. Sets of manufacturing rules can form profiles that can be interchanged for different machines, leading to different solutions to the same engineering problem. Finally, the system designs parts in a generative fashion i.e. without a starting geometry. Consequently, this system helps to alleviate bias, fixation and prejudices in the design phase, which has been highlighted as a major issue.

### 6. Conclusions and Future Perspectives

This has demonstrated that the agent-based, generative design tool is capable of simultaneously designing, structurally optimising and appraising the manufacturability of an AM concept part. The system converged upon a final part concept, with stable volume and shape. The system exploited opportunities to significantly light-weight the part, whilst preserving manufacturability and without compromising the required functionality. The significance of this research lies in the ability to create part concepts using only a description of the part's functional requirements and available manufacturing capabilities. This concurrent and generative approach represents a novel method for concept generation amidst the complexities of design for AM. This research will continue to build capabilities to handle increasingly complex design and manufacturing constraints. It will also focus on creating part concepts that can be manufactured reliably.

According to a further example embodiment, the following process takes place:
i. As a preliminary step, import all information relating to that describes the design problem to a simulation tool according to an example embodiment. This information preferably includes one or more of the optimisation target (e.g. mass reduction), part position and orientation within a machine, load cases, and areas of known geometry such as holes for fastenings, flat planes for mounting surfaces and areas that must be kept clear for assembly or tool-accessibility requirements. The user also selects the manufacturing resource (e.g. 3D printer), which in turn imports all of the rules for manufacturability (overhanging angles, tool accessibility dimensions etc.). Information from the design problem description and the manufacturing resource information will both contribute to the definition of the boundary conditions (allowable volume and voxel resolution).
ii. Material placement: One or more ants are then created and are then commanded to follow a predetermined path within a virtual design space comprising a plurality of volume elements. The ants are commanded to visit every voxel in the design space. By checking each voxel against manufacturability rules, material is placed in all feasible locations. This may be referred to as ‘Smart-Filling’.
iii. Material Removal: Remove voxels that would be removed in a post-processing step, such as CNC machining. This is to ensure that FEA is being conducted on the final part geometry.
iv. Conduct first FEA of all simulation scenarios (e.g. load cases)
v. The first iteration of the optimisation algorithm now commences
vi. The finite element analysis simulation data is returned to the simulation tool. The simulation tool then maps the FEA data onto the relevant voxels (e.g. stress data).
vii. These simulation values (e.g. stress) are scaled and otherwise mathematically manipulated to present the data in a format that is readable and useful to the ants (e.g. normalised between 0 and 1). These are then combined with pheromones that are associated with design requirements, such as areas that are known to need material.
viii. Sub-iterations now commence. Here, a window is defined. This window represents the current optimisation target (e.g. reduce mass by 5% compared with the previous iteration). This is not to be confused with the overall optimisation objective, which is to reduce the mass as much as possible. The simulation tool must now adjust the sensitivity of each ant to the pheromone sources. This is a threshold value such that only the strongest pheromones are addressed first. The threshold is then adjusted (reduced) until the design (e.g. mass of the part) sits within the window.
   a. Set/adjust optimisation target (window values)
   b. The sensitivity of each ant to the pheromone sources is set
   c. Smart-Filling occurs at the current sensitivity value
   d. Identify whether all design requirements have been met using the current sensitivity
   e. Alter sensitivity until all requirements have been met
   f. Go to (b) if not met
ix. Go to (iii) if not met

A method according to one or more example embodiments can comprise any combination of the apparatus or tool aspects. Methods according to these further examples can be described as computer-implemented in that they require processing and memory capability.

The tool according to one or more example embodiments is described as configured or arranged to carry out certain functions. This configuration or arrangement could be by use of hardware or middleware or any other suitable system. In one or more examples, the configuration or arrangement is by software. Thus according to one aspect there is provided a program which, when loaded onto at least one hardware module, configures the at least one hardware module to become the tool according to any of the preceding aspects.

According to a further aspect there is provided a program which when loaded onto the at least one hardware module configures the at least one hardware module to carry out the method steps according to any of the preceding method definitions or any combination thereof.

In general the hardware mentioned may comprise the elements listed as being configured or arranged to provide the functions defined. For example this hardware may include at least one sensor, memory, processing, and communications circuitry for the tool and memory, processing and communications circuitry for a system according to an example embodiment.

Example embodiments described herein can be implemented in digital electronic circuitry, or in computer hardware, firmware, software, or in combinations of them. Example embodiments can be implemented as a computer program or computer program product, i.e., a computer program tangibly embodied in an information carrier, e.g., in a machine-readable storage device or in a propagated signal, for execution by, or to control the operation of, one or more hardware modules. A computer program can be in the form of a stand-alone program, a computer program portion or more than one computer program and can be written in any form of programming language, including compiled or interpreted languages, and it can be deployed in any form, including as a stand-alone program or as a module, component, subroutine, or other unit suitable for use in a data processing environment.

Method steps according to example embodiments described herein can be performed by one or more programmable processors executing a computer program to perform functions of the invention by operating on input data and generating output. Tools according to one or more example embodiments can be implemented as programmed hardware or as special purpose logic circuitry, including e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions coupled to one or more memory devices for storing instructions and data.

Test scripts and script objects can be created in a variety of computer languages. Representing test scripts and script objects in a platform independent language, e.g., Extensible Markup Language (XML), allows one to provide test scripts that can be used on different types of computer platforms.

A first example of a set of computer-readable instructions for implementing an example embodiment of the present invention is as follows:

WHILE manufacturing requirements are not met

WHILE a source of pheromone still exists

FOR each Ant in Colony

MOVE ant
IF complies with manufacturing rules

PROCESS materia1

ENDIF
REMOVE pheromones within diffusion radius

ENDFOR
CALCULATE stress in generated part using FEA
IF manufacturing requirements not met

CREATE new Pheromones from normalized

stress data

ADJUST sensitivity to pheromone scents
RESPAWN Ants onto baseplate
DELETE all material

ELSE

SAVE geometry of generated part

ENDIF

ENDWHILE

ENDWHILE

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. A computer-implemented method of generating a representation of an object to be manufactured, the representation comprising geometric parameters of a candidate design of the object, wherein the method comprises:
a step of simulating manufacture of the object in a design space comprising a plurality of volume elements, wherein the step of simulating manufacture comprises, at each volume element:
i) performing a check to determine if a simulated manufacturing operation, comprising adding material to and/or removing material from the volume element, is permitted based on:
a) a manufacturing protocol which defines one or more manufacturing parameters relating to the manufacture of the object;
b) a design protocol which defines one or more design parameters relating to the object to be manufactured; and
c) at least one boundary condition which defines at least one boundary of a design region within which material forming the object to be manufactured is allowed to exist;
and
ii) if the simulated manufacturing operation is determined to be permitted, performing the simulated manufacturing operation in order to derive the candidate design.

2. A method as claimed in claim 1, wherein the manufacturing protocol comprises instructions and/or a set of values which relate to:
i) a parameter of a manufacturing process for manufacturing the object and/or
ii) at least one parameter of an additive manufacturing process, at least one parameter of a subtractive manufacturing process, or at least one parameter of a hybrid manufacturing process.

3. (canceled)

4. A method as claimed in claim 1, wherein the manufacturing protocol defines a rule arising as a consequence of at least one geometric constraint of the intended manufacturing system that is to be used for manufacturing the object.

5. A method as claimed in claim 4, wherein the geometric constraint relates to least one tool accessibility constraint.

6. A method as claimed in claim 1, wherein the design protocol includes a definition of an initial starting geometry of the object to be manufactured and/or a definition of one or more required attributes of the object to be manufactured.

7. A method as claimed in claim 1, wherein the at least one boundary condition defines a) one or more regions where material forming the object is required and/or b) one or more regions where material forming the part is forbidden.

8. A method as claimed in claim 1 wherein the design space comprises a virtual design space and wherein each volume element comprises a cube.

9. (canceled)

10. A method as claimed in claim 1, wherein the representation generated by the step of simulating manufacture of the object comprises a plurality of interconnected volume elements and/or a set of computer-readable instructions and/or a visual representation.

11. (canceled)

12. (canceled)

13. A method as claimed in claim 1, wherein the step of simulating manufacture of the object is performed by at least one virtual agent wherein the at least one virtual agent is an additive agent, a subtractive agent or a hybrid agent.

14. (canceled)

15. A method as claimed in claim 13, wherein the at least one virtual agent is operable to follow movement instructions comprising a pheromone map or is operable to follow a predetermined path

16. A method as claimed in claim 15, wherein the pheromone map is generated based on an analysis of a previously generated representation of the object to be manufactured which comprises a method of finite element analysis.

17. A method as claimed in claim 1, wherein the method further comprises:
an analysis step which comprises a simulation of a loading condition placed upon the representation generated by the step of simulating manufacture of the object to obtain analysis data and wherein the analysis step involves a method of finite element analysis.

18-20. (canceled)

21. A data processing tool for generating a representation of an object to be manufactured, the representation comprising geometric parameters of a candidate design of the object, wherein the tool comprises:
a simulation unit configured to simulate manufacture of the object in a design space comprising a plurality of volume elements, wherein the simulation unit is operable at each volume element to:
i) perform a check to determine if a simulated manufacturing operation comprising adding material to and/or removing material from the volume element is permitted based on:
a) a manufacturing protocol which defines one or more manufacturing parameters relating to the manufacture of the object;
b) a design protocol which defines one or more design parameters relating to the object to be manufactured; and
c) at least one boundary condition which defines at least one boundary of a design region within which material forming the object to be manufactured is allowed to exist,
and
ii) to perform the simulated manufacturing operation in order to derive the candidate design if the simulated manufacturing operation is determined to be permitted.

22. A tool as claimed in claim 21, further comprising one or more of:
a manufacturing protocol storage unit configured to store the manufacturing protocol;
a design protocol storage unit configured to store the design protocol; and
a boundary condition storage unit configured to store the at least one boundary condition.

23. (canceled)

24. A tool as claimed in claim 21 further comprising one or more of:
i) a representation storage unit configured to store the representation;
ii) a display operable to display the simulated manufacture performed by the simulation unit;
iii) a display operable to display the representation;
iv) a manufacturing apparatus operable to receive the representation and to manufacture an object according to the representation.

25. (canceled)

26. (canceled)

27. A simulation unit for simulating the manufacture of an object, comprising:
a virtual design space comprising a plurality of volume elements; and
at least one virtual agent operable to move between volume elements within the virtual design space element wherein at each volume element the at least one virtual agent is operable to:
i) perform a check to determine if a simulated manufacturing operation is permitted at the volume element;
and
ii) perform the simulated manufacturing operation in order to derive a candidate design of the object if the simulated manufacturing operation is determined to be permitted.

28. A simulation unit as claimed in claim 27, wherein the manufacturing operation performed by the at least one virtual agent comprising adding material to a given volume element and/or subtracting material from a given volume element.

29. A simulation unit as claimed in claim 28 wherein the simulation unit is operable to perform said check based on one or more of:
i) at least one manufacturing rule relating to the manufacture of the object;
ii) at least one design rule relating to the object to be manufactured; and
ii) at least one boundary condition which defines at least one boundary of a design region within which material forming the object to be manufactured is allowed to exist.

30. A simulation unit as claimed in claim 27, further comprising an electronic display for displaying the virtual design space.

31. A computer program comprising instructions which, when the program is executed by a computer, cause the computer to carry out the method according to claim 1.

32. A computer readable storage medium comprising instructions which, when the program is executed by a computer, cause the computer to carry out the method according to claim 1.

33. (canceled)
